(19) United States
(12) Patent Application Publication
(10) Pub. No.: US 2006/0048599 A1
(43) Pub. Date: Mar. 9, 2006

(54) Bicycle pedal platform

(76) Inventor: Leon Y. Wald, Temple, TX (US)

Correspondence Address: Richard C. Litman;LITMAN LAW OFFICES, LTD., P.O. Box 15035, Arlington, VA, 22215, US

(21) Appl. No.: 10/934,456

(22) Filed: Sep. 7, 2004

(51) Int. Cl. G05G 1/14

(52) U.S. Cl. 74/594.6

(57) ABSTRACT

An adjunct for a bicycle pedal, which adjunct includes a platform having a contoured heel cup at one end thereof. The platform and heel cup are arranged to partially encase the heel and part of the sole of a shoe therein. A member is positioned on the bottom surface of the platform for receiving and engaging the pedal of the bicycle. The member is dimensioned to encompass the pedal of any conventional stationery exercise bicycle. Hook and loop straps are disposed on the platform and provide means for attaching the platform to the user's shod foot.

### BACKGROUND OF THE INVENTION

1. Field of the Invention

The present invention generally relates to exercise equipment. More specifically, the present invention is drawn to an adjunct for a stationery bicycle or the like.

2. Description of the Related Art

A consistent exercise regimen is recommended for almost everyone, even those of us who may be partially disabled. Walking has been recognized as one of the most efficient exercises available; however, if one's disability precludes walking, riding a stationery bicycle has proven to be a satisfactory substitute. Unfortunately, there are some people whose disability is related to one or both feet. Such a disability makes it impossible to walk for any significant distance. It also may be difficult to keep the injured foot in contact with the pedal of a stationary exercise bicycle, thus preventing or seriously limiting participation in either exercise.

The related art is rife with adjuncts to aid a cyclist to engage the pedals of a bicycle. However, most of the adjuncts are geared to cyclists who participate in touring, racing or off-road riding. None of the aforestated related art appears to address the problem of a user with a disabled foot or feet. Thus a bicycle pedal adjunct solving the aforementioned problem would certainly be a desired and needed addition to the art.

### SUMMARY OF THE INVENTION

The present invention is an adjunct for a bicycle pedal, which adjunct includes a platform having a contoured heel cup at one end thereof. The platform and heel cup are arranged to partially encase the heel and part of the sole of a shoe therein. A member is positioned on the bottom surface of the platform for encompassing and engaging the pedal of the bicycle. The member is dimensioned to encompass the pedal of any conventional stationery exercise bicycle. Hook and loop straps are disposed on the platform and provide means for attaching the platform to the user's shod foot. The adjunct can be used on either or both feet.

Accordingly, the present invention presents a device that allows a user having a disabled foot to participate in exercise that employs a stationery bicycle. Use of the device can be accomplished without alteration of the bicycle's pedal. A user can securely don the device with minimum effort.

The invention provides for improved elements and arrangements thereof for the purposes described which are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of an adjunct for a stationery bicycle pedal according to the present invention.

FIG. 2 is a side perspective view of an adjunct for a stationery bicycle pedal according to the present invention.

FIG. 3 is a top view of an adjunct for a stationery bicycle pedal according to the present invention.

FIG. 4 is a bottom view of an adjunct for a stationery bicycle pedal according to the present invention.

Similar reference characters denote corresponding features consistently throughout the attached drawings.

### DETAILED DESCRIPTION OF THE PREFERRED EMBODIMENT

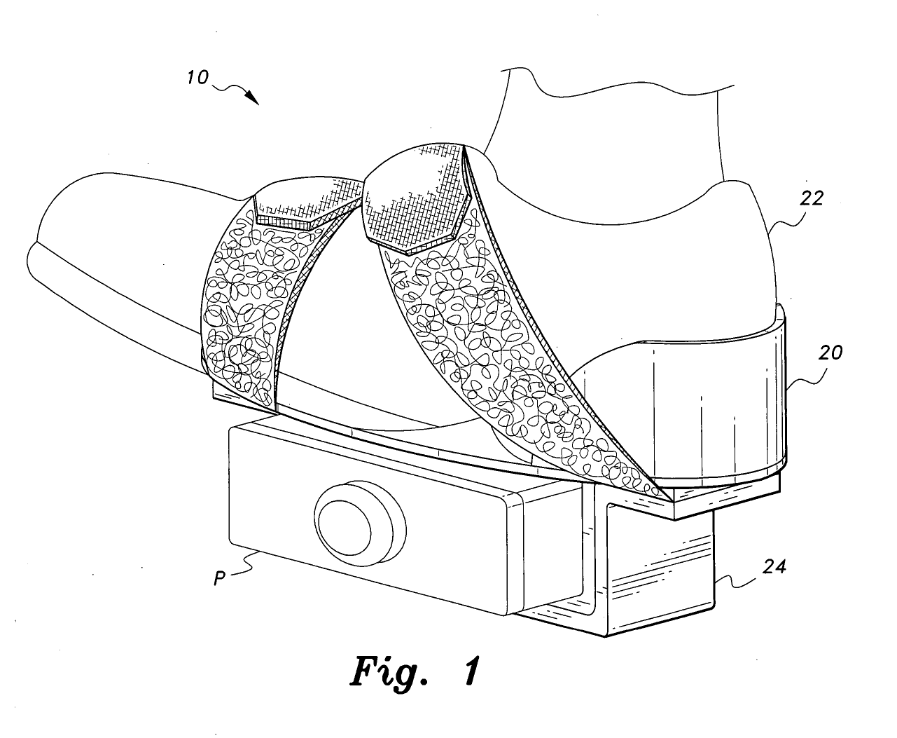

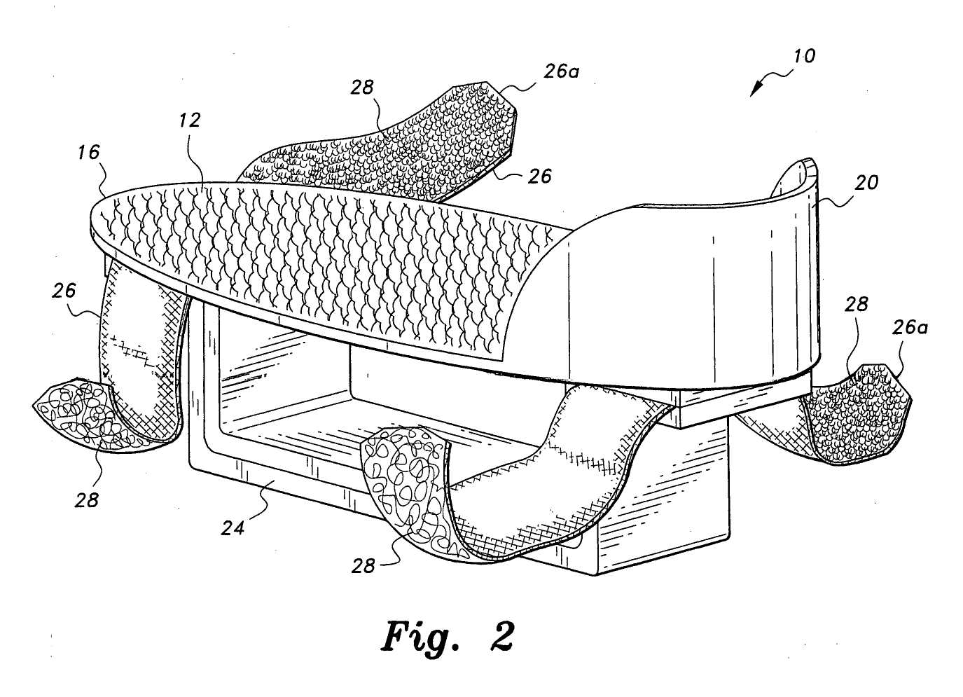

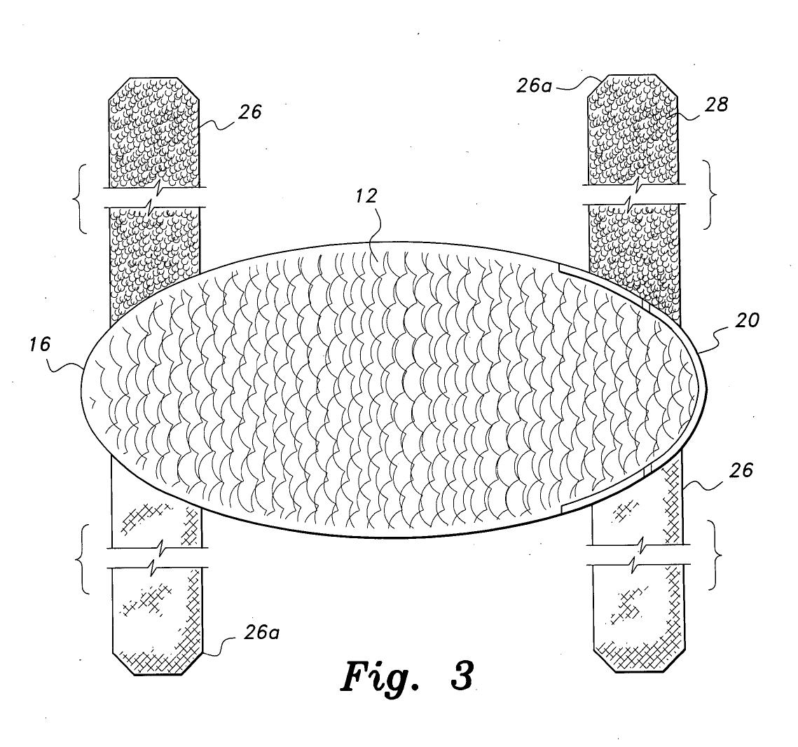

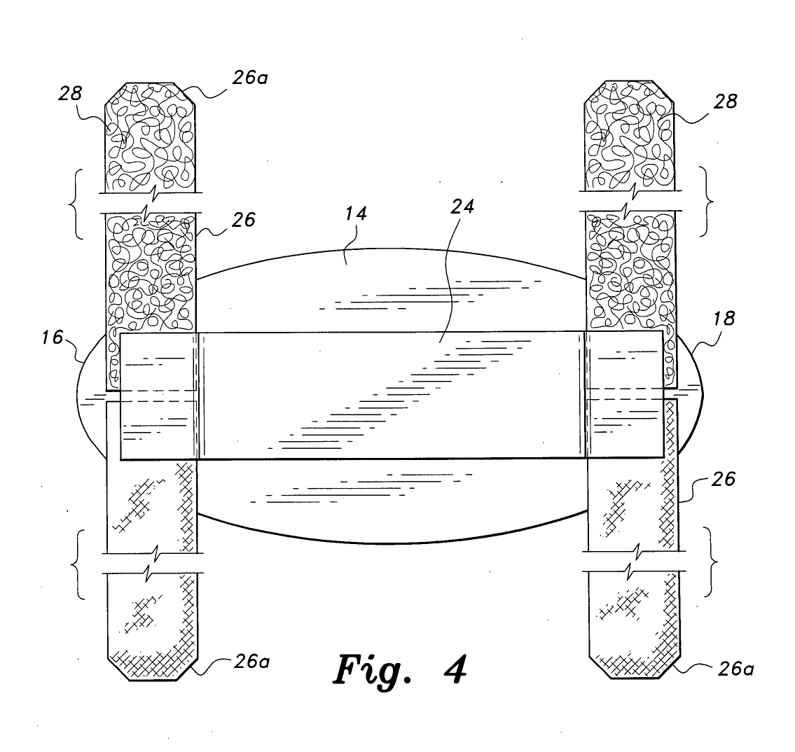

Attention is directed to FIGS. 1-4 wherein the adjunct of the present invention is generally indicated at 10. Adjunct 10 comprises a platform having planar top surface 12, planar bottom surface 14, front-end portion 16 and rear-end portion 18. The platform is approximately 9 inches long and 3.5 inches wide. These dimensions have been found adequate to conform to most shoe sizes. It is recognized that the platform may be made in other dimensions to conform to shoe sizes that may be out of the normal range. As presently contemplated, the platform is fabricated from a rigid material in order to provide proper support. Although plastic is the preferred material it is recognized that other materials (wood, metal, etc.) may be utilized. The platform can be rounded at both ends if desired. A heel cup 20 is affixed on top surface 12 at the rear-end portion 18 of the platform. The cup is contoured to receive a rounded heel of a shoe 22. A pedal engaging and receiving member 24 is attached to the bottom surface 14 of the platform. Pedal-receiving member 24 is U-shaped and configured with an opening therein to receive the pedal P of the stationery bicycle (not shown). Member 24 is fabricated from a suitable rugged, pliable material so that a user may easily walk a short distance from a chair to the bicycle without damaging floor surfaces. Plural straps 26 are attached to the bottom surface 14. Each strap has a free end 26a and each strap has hook and loop fasteners 28 disposed thereon.

As indicated above, a user merely has to place his/her shod foot on the platform so that the heel of the shoe rests within the heel cup and secure the ends of the straps together. This endeavor will require a minimum of manual dexterity. As the user mounts the bicycle, the user's foot is positioned so that the bicycle's pedal is inserted into the opening of the pedal receiving member. This scenario allows for a stable connection between the foot and the pedal.

It is to be understood that the present invention is not limited to the embodiment described above, but encompasses any and all embodiments within the scope of the following claims.

I claim:

1. A bicycle pedal adjunct, comprising:
a platform for supporting a shoe thereon, said platform having a planar upper surface, a planar bottom surface, a front end portion and a rear end portion;
a contoured heel cup fixed on said planar upper surface at said rear end portion; and
a bicycle pedal-receiving member fixed on said bottom surface.

2. The bicycle pedal adjunct according to claim 1, further including, plural fasteners for securing the shoe to said platform.

3. The bicycle pedal adjunct according to claim 1, wherein said platform is fabricated from a rigid material.

4. The bicycle pedal adjunct according to claim 1, wherein said pedal-receiving member is fabricated from a rugged pliable material.

5. A bicycle pedal adjunct, comprising:
a platform for supporting a shoe thereon, said platform being fabricated from a rigid material and having a planar upper surface, a planar bottom surface, a front end portion and a rear end portion;
a contoured heel cup fixed on said planar upper surface at said rear end portion; and
a bicycle pedal receiving member fixed on said bottom surface, said receiving member being fabricated from a rugged pliable material.

6. The bicycle pedal adjunct according to claim 5, wherein said pedal receiving member is of U-shaped configuration and has an opening therein for receiving the pedal.

7. The bicycle pedal adjunct according to claim 5, further including, plural fasteners for securing the shoe to said platform.

8. A bicycle pedal adjunct, comprising:
a platform for supporting a shoe thereon, said platform being fabricated from a rigid material and having a planar upper surface, a planar bottom surface, a front end portion and a rear end portion;
a contoured heel cup fixed on said planar upper surface at said rear end portion;
a bicycle pedal receiving member fixed on said bottom surface; and
plural fasteners for securing the shoe to said platform.

9. The bicycle pedal adjunct according to claim 8, wherein said plural fasteners are straps, said straps having free ends.

10. The bicycle pedal adjunct according to claim 9, wherein said straps have surfaces and wherein hook and loop fastening devices are disposed on said surfaces.

11. The bicycle pedal adjunct according to claim 10, wherein said pedal receiving member is of U-shaped configuration and has an opening therein for receiving the pedal.

12. The bicycle pedal adjunct according to claim 11, wherein said pedal receiving member is fabricated from a rugged pliable material.
